(19) United States
(12) Patent Application Publication
(10) Pub. No.: US 2026/0313511 A1
(43) Pub. Date: Oct. 8, 2026

(54) RETAINING PSCELL ACCESS CONDITION WITH PCELL ROBUSTNESS

(71) Applicant: Nokia Technologies Oy, Espoo (FI)

(72) Inventors: Umur Karabulut, Munich (DE); Ahmad Awada, Munich (DE); Jedrzej Stanczak, Wroclaw (PL); Halit Murat Gürsu, Munich (DE)

(73) Assignee: Nokia Technologies Oy, Espoo (FI)

(21) Appl. No.: 19/483,349

(22) PCT Filed: Apr. 18, 2024
(86) PCT No.: PCT/EP2024/060479

§ 371 Date: Nov. 11, 2025

(30) Foreign Application Priority Data
May 12, 2023 (FI) 20235541

(51) Int. Cl. H04W 36/36; H04W 36/00

(52) U.S. Cl. CPC H04W 36/362; H04W 36/0069

(57) ABSTRACT

Described herein is a user equipment (UE) configured for supporting a conditional handover (CHO) procedure in a multi connectivity (MC) setup involving a source network element and at least one target network element, the source network element being associated with a first primary cell (PCell) and optionally a first primary secondary cell (PSCell) serving the UE; the target network element being associated with a second PCell and one or more second PSCells for supporting a conditional PSCell addition and change (CPAC) procedure; and the UE comprising: at least one processor; and at least one memory storing instructions that, when executed by the at least one processor, cause the UE at least to: receive, from the source network element, information indicative of: one or more CHO configurations and at least one corresponding CHO execution condition associated with the second PCell, and one or more CPAC configurations and corresponding one or more CPAC execution conditions thereof each associated with a respective second PSCell; continuously determine whether the CHO execution condition and/or the one or more CPAC execution conditions are met; and based on determining that the CHO execution condition is met while none of the one or more CPAC execution conditions are met: upon detecting a radio link problem state associated with the first PCell before any one of the one or more CPAC execution conditions is determined to be met, measuring continuity of the radio link problem state and comparing the measured continuity with at least one threshold, if the measured continuity is above the at least one threshold, execute one CHO configuration of the one or more CHO configurations.

### TECHNOLOGY

The present disclosure generally relates to handover procedures, and particularly relates to methods, apparatuses, and systems for supporting conditional handover (CHO) procedures in a DC (Dual Connectivity) or even MC (Multi-Connectivity) setup.

### BACKGROUND

Any discussion of the background art throughout the specification should in no way be considered as an admission that such art is widely known or forms part of common general knowledge in the field.

CHO (Conditional Handover) procedure has been introduced in the 3rd Generation Partnership Project (3GPP) Release 16 to improve mobility robustness. Generally speaking, in the case of CHO, the network may prepare multiple target cells where each conditional handover reconfiguration is associated with a CHO execution condition that would be evaluated by the UE. The CHO execution condition generally refers to a measurement ID associating a measurement object with a reporting configuration and is typically configured by the source base station (e.g., a gNB or the like). The reporting configuration generally defines the measurement event (e.g., A3 or A5 or the like) which would trigger the reporting of the configured measurements. The same measurement events are also configured by the serving UE which will trigger the CHO execution upon the configured measurement configuration is met. Whenever the CHO execution condition is met, the corresponding target configuration may be selected, and handover would be executed towards the selected target cell.

In Release 17, CHO in MR (Multi-RAT (Radio Access Technology))-DC (Dual Connectivity) is generally limited to the scenario where the target MN (Master Node) can prepare a single target PSCell (Primary Secondary Cell), e.g., under the control of an SN (Secondary Node). However, this would limit the usefulness of the CHO MR-DC feature where UE may need to access different target PSCells when the CHO needs to be executed. Thus, there is a general need (e.g., in future 3GPP Releases) to specify mechanisms for CHO in MR-DC where target MN can prepare multiple target PSCells for the same target PCell.

In one WID (Work Item Description) of further NR (New Radio) mobility enhancements, one objective has been proposed to address the scenario of CHO+CPAC (Conditional PSCell Addition and Change) as follows:
To specify CHO including target MCG and candidate SCGs for CPC/CPA in NR-DC [RAN3, RAN2]:
   CHO including target MCG and target SCG is used as the baseline.

In short, the focus of the above objective may be seen to provide a configuration to a UE which may consist of both CHO and CPAC configurations, i.e., UE would conditionally handover to both PCell and PSCell, considering the execution conditions of each cell given in the handover configuration.

Further, in one of the meetings, the following has been agreed:
RAN2 agrees to support the simultaneous evaluation of CHO and CPC in Rel-18.
The UE should not need to unpack any of the nested conditional configuration containers in order to measure, according to the agreement above.

With this agreement, it was generally agreed that the UE should evaluate the CHO condition and CPC condition simultaneously.

Later, a further agreement has been achieved as well:
For the CHO+CPC (Conditional PSCell Change) case:
   When both CHO and CPC conditions are met, both CHO and CPC cell change is executed.
   Baseline: The UE waits until both CHO and CPC conditions are met (always). (Furthermore, it is assumed that if needed the network can provide a complementary CHO-only configuration, to avoid failures in deployments where failure would otherwise be likely to happen).
   Alternative: FFS (For Further Study) If when CHO condition is met, but CPC condition is not met, CHO execution is triggered (and somehow source SCG can be released). If allowed in the new configuration the UE may continue evaluation of CPC/CPA (Conditional PSCell Addition) conditions.

However, generally speaking, in either the baseline or the alternative illustrated above, when the CHO condition is met but the CPAC condition is not met, there would be a trade-off between waiting for the CPAC condition to be met and executing the single connectivity handover.

Therefore, in view of at least some or all of the issues discussed above, there appears to exist a general need to propose new mechanisms/techniques for use in supporting CHO+CPAC in MR-DC, particularly in an efficient, flexible yet reliable manner, thereby mitigating the trade-off between the two options mentioned above. Specifically, there appears to exist a need to propose new mechanisms/techniques for supporting retaining PSCell access condition (thus, maintaining DC/high throughput) while maintaining PCell robustness during cell switch (mobility) as much as possible.

### SUMMARY

In accordance with an aspect of the present disclosure, there is provided a user equipment (UE) configured for supporting a conditional handover (CHO) procedure in a multi connectivity (MC) setup involving a source network element and at least one target network element, the source network element being associated with a first primary cell (PCell) and optionally a first primary secondary cell (PSCell) serving the UE; the target network element being associated with a second PCell and one or more second PSCells for supporting a conditional PSCell addition and change (CPAC) procedure; and the UE comprising:
at least one processor; and
at least one memory storing instructions that, when executed by the at least one processor, cause the UE at least to:
receive, from the source network element, information indicative of: one or more CHO configurations and at least one corresponding CHO execution condition associated with the second PCell, and one or more CPAC configurations and corresponding one or more CPAC execution conditions thereof each associated with a respective second PSCell;
continuously determine whether the CHO execution condition and/or the one or more CPAC execution conditions are met; and
based on determining that the CHO execution condition is met while none of the one or more CPAC execution conditions are met:
   upon detecting a radio link problem state associated with the first PCell before any one of the one or more CPAC execution conditions is determined to be met, measuring continuity of the radio link problem state and comparing the measured continuity with at least one threshold, if the measured continuity is above the at least one threshold, execute one CHO configuration of the one or more CHO configurations.

In some examples, the UE is further caused to:
based on determining that a CPAC execution condition of the one or more CPAC execution conditions is met before the radio link problem state associated with the first PCell is detected or before the measured continuity of radio link problem state associated with the first PCell becomes above the at least one threshold.

In some examples, the at least one threshold is preconfigured to the UE.

In some examples, the measured continuity and comparison with the at least one threshold involve at least one of: a count of out-of-sync indications detected by the UE relative to a predetermined indication threshold N, or a running period of a preconfigured timer relative to a predetermined timing threshold T, where each of N and T is a value larger than or equal to 0.

In some examples, the measured continuity and comparison with the at least one threshold involve:
if the count of out-of-sync indications detected by the UE is larger than the predetermined indication threshold N, and/or if the running period of the preconfigured timer is larger than the predetermined timing threshold T, executing the one CHO configuration of the one or more CHO configurations.

In some examples, the UE is further caused to:
receive the at least one threshold from the source network element.

In some examples, the UE is configured to receive the preconfigured at least one threshold from the source network element in a radio resource control (RRC) reconfiguration message.

In some examples, if there are at least two CHO configurations, the executing one CHO configuration involves:
selecting, based on a predetermined criterion, one CHO configuration from the at least two CHO configurations for execution; and
executing the selected CHO configuration.

In some examples, the predetermined criterion involves at least one of: a predetermined configuration prioritization, a corresponding CPAC condition status, such as time to trigger, TTT, status of each CPAC configuration, a corresponding signal strength of the respective second PSCell associated with each CPAC configuration, or a predetermined bearer mapping.

In some examples, the one or more CHO configurations relate to a radio access technology (RAT) different from that of the one or more CPAC configurations.

In accordance with another aspect of the present disclosure, there is provided a source network element configured for supporting a conditional handover (CHO) procedure a multi connectivity (MC) setup involving at least one target network element and a user equipment (UE) served by a first primary cell (PCell) and optionally a first primary secondary cell (PSCell) of the source network element; the target network element being associated with a second PCell and one or more second PSCells for supporting a conditional PSCell addition and change (CPAC) procedure; and the source network element comprising:
at least one processor; and
at least one memory storing instructions that, when executed by the at least one processor, cause the source network element at least to:
   receive, from the target network element, one or more CHO configurations associated with the second PCell, and one or more CPAC configurations each associated with a respective second PSCell;
   transmit, to the UE, information indicative of: the one or more CHO configurations and the one or more CPAC configurations, together with at least one corresponding CHO execution condition associated with the second PCell and corresponding one or more CPAC execution conditions respectively associated with the one or more second PSCells; and
   transmit, to the UE, information indicative of at least one preconfigured threshold for enabling the UE for detecting a radio link problem state associated with the first PCell, measuring continuity of the radio link problem state and comparing the measured continuity with the at least one preconfigured threshold, particularly in the case that it is determined that the CHO execution condition is met while none of the one or more CPAC execution conditions are met.

In accordance with yet another aspect of the present disclosure, there is provided a method of a user equipment (UE) for supporting a conditional handover (CHO) procedure in a multi connectivity (MC) setup involving a source network element and at least one target network element, the source network element being associated with a first primary cell (PCell) and optionally a first primary secondary cell (PSCell) serving the UE; the target network element being associated with a second PCell and one or more second PSCells for supporting a conditional PSCell addition and change (CPAC) procedure; and the method comprising:
receiving, from the source network element, information indicative of: one or more CHO configurations and at least one corresponding CHO execution condition associated with the second PCell, and one or more CPAC configurations and corresponding one or more CPAC execution conditions thereof each associated with a respective second PSCell;
continuously determining whether the CHO execution condition and/or the one or more CPAC execution conditions are met; and
based on determining that the CHO execution condition is met while none of the one or more CPAC execution conditions are met:
   upon detecting a radio link problem state associated with the first PCell before any one of the one or more CPAC execution conditions is determined to be met, measuring continuity of the radio link problem state and comparing the measured continuity with at least one threshold, if the measured continuity is above the at least one threshold, executing one CHO configuration of the one or more CHO configurations.

In accordance with yet another aspect of the present disclosure, there is provided a method of a source network element for supporting a conditional handover (CHO) procedure in a multi connectivity (MC) setup involving at least one target network element and a user equipment (UE) served by a first primary cell (PCell) and optionally a first primary secondary cell (PSCell) of the source network element; the target network element being associated with a second PCell and one or more second PSCells for supporting a conditional PSCell addition and change (CPAC) procedure; and the method comprising:
receiving, from the target network element, one or more CHO configurations associated with the second PCell, and one or more CPAC configurations each associated with a respective second PSCell;
transmitting, to the UE, information indicative of: the one or more CHO configurations and the one or more CPAC configurations, together with at least one corresponding CHO execution condition associated with the second PCell and corresponding one or more CPAC execution conditions respectively associated with the one or more second PSCells; and
transmitting, to the UE, information indicative of at least one preconfigured threshold for enabling the UE for detecting a radio link problem state associated with the first PCell, measuring continuity of the radio link problem state and comparing the measured continuity with the at least one preconfigured threshold, particularly in the case that it is determined that the CHO execution condition is met while none of the one or more CPAC execution conditions are met.

In accordance with yet another aspect of the present disclosure, there is provided a computer program comprising instructions for causing an apparatus (e.g., a UE or a source network element) to perform the respective methods as disclosed in the present disclosure.

In accordance with a further aspect of the present disclosure, there is also provided computer-readable storage medium storing the computer program according to the preceding aspect.

Further, according to some example embodiments, there is provided a memory storing computer readable instructions for causing an apparatus to perform the method as disclosed in the present disclosure.

Moreover, according to some example embodiments, there is also provided a user equipment (UE) configured for supporting a conditional handover (CHO) procedure in a multi connectivity (MC) setup involving a source network element and at least one target network element, the source network element being associated with a first primary cell (PCell) and optionally a first primary secondary cell (PSCell) serving the UE; the target network element being associated with a second PCell and one or more second PSCells for supporting a conditional PSCell addition and change (CPAC) procedure; and the UE comprising respective suitable means configured for performing the respective steps as disclosed in the present disclosure.

Similarly, according to some example embodiments, there is provided a source network element configured for supporting a conditional handover (CHO) procedure in a multi connectivity (MC) setup involving at least one target network element and a user equipment (UE) served by a first primary cell (PCell) and optionally a first primary secondary cell (PSCell) of the source network element; the target network element being associated with a second PCell and one or more second PSCells for supporting a conditional PSCell addition and change (CPAC) procedure; and the source network element comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use and is applicable in broader contexts.

Notably, it is understood that methods according to the present disclosure relate to methods of operating the apparatuses (or systems) according to the above example embodiments and variations thereof, and that respective statements made with regard to the apparatuses (or systems) likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processors, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a CHO+CPAC scenario and corresponding signaling/messaging according to some examples of the present disclosure,

FIG. 2 schematically illustrates another example of a CHO+CPAC scenario and corresponding signaling/messaging according to some example embodiments of the present disclosure,

FIG. 3 schematically illustrates an example of an implementation of an apparatus according to some example embodiments of the present disclosure,

FIG. 4 schematically illustrates an example of a method flow performed by an apparatus (e.g., a UE) according to some example embodiments of the present disclosure, and

FIG. 5 schematically illustrates another example of a method flow performed by an apparatus (e.g., a source network element/entity) according to some example embodiments of the present disclosure.

### DESCRIPTION OF EXAMPLE EMBODIMENTS

Notably, identical or like reference numbers used in the figures of the present disclosure may, unless indicated otherwise, indicate identical or like elements. Similarly, identical or like messages (as well as the contents comprised therein) used in the figures of the present disclosure may, unless indicated otherwise, indicate identical or like messages (and the contents therein), such that repeated description thereof may be omitted for reasons of conciseness.

In the following, different exemplifying embodiments will be described using, as an example of a communication network to which examples of embodiments may be applied, a communication network architecture based on 3GPP standards for a communication network, such as a 5G/NR/IOT, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0(2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the El interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the El interface connected with the gNB-CU-CP and the F1-U interface connected with the gNB-DU, e.g., according to 3GPP TS 38.401 V16.6.0(2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0(2017-03) section 11 incorporated by reference.

A gNB supports different protocol layers, e.g., Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0(2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g., RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC INACTIVE state when an RRC connection has been established.

In RRC CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g., intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g., an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that, in the present specification, processing portions should not be only considered to represent physical portions of one or more processors but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

Before going into detail about the example embodiments of the present disclosure, it may still be worthwhile to briefly go through some exemplary general aspects of Conditional Handover (CHO) related techniques/procedures that may be considered useful for understanding the present disclosure.

In a broad sense, the present disclosure may be considered to relate to 5G New Radio (NR) and, in particular, to Multi-RAT Mobility (MRM) concept targeted for 3GPP Release 18 and beyond which enables and improves mobility/cell-changes in RAN where the CU-DU (Central-Unit-Distributed-Unit) structure (or the like) is deployed, i.e., enabling operations between different DU (inter-DU) of different vendors via CU (involving the Control Plane or/and User Plane aspects of the Central-Unit, CU-CP, CU-UP).

As mentioned above, the CHO procedure has been introduced to improve mobility robustness. In particular, in the case of CHO, the network may prepare multiple target cells where each conditional handover reconfiguration is associated with a CHO execution condition that is evaluated by the UE. The CHO execution condition may refer to a measurement ID associating a measurement object with a reporting configuration and may be configured by source gNB. The reporting configuration may generally define the measurement event (e.g., A3 or A5) which may trigger the reporting of the configured measurements. The same measurement events may also be configured by the UE which would trigger the CHO execution upon the configured measurement configuration being met. Whenever a CHO execution condition is met, the corresponding target configuration is selected, and the handover is executed towards the selected target cell (e.g., a target PCell of a target MN). In short, the CHO procedure may generally be seen as being designed so that UE can execute the handover autonomously without the need for the serving cell to trigger the handover (HO) execution after receiving a measurement report from the UE.

In Release 16, another procedure referred to as CPC (Conditional PSCell (Primary Secondary Cell) Change) has also been specified, but mainly for intra-SN (Secondary Node) scenarios. Later, CPC has been extended in Release 17 for inter-SN scenarios where it generally has two flavors, namely: MN (Master Node)-initiated CPC and SN-initiated CPC. Some further enhancements proposed for the mobility work item in Release 18 also mentioned the following objectives, including specifying CHO including inter alia target MCG (Master Cell Group) and candidate SCG(s) (Secondary Cell Group) for CPC/CPA (Conditional PSCell Addition) in NR-DC. Sometimes, CPC/CPA may also be referred to as CPAC (Conditional PSCell Addition and Change). Generally speaking, in the case of CHO in NR-DC, the target MN would then provide CHO preparation for PCell (Primary Cell) along with CPAC preparations for PSCells. The UE would then evaluate the CPAC conditions for all PSCells that are configured by the network.

On the other hand, as briefly mentioned above, in Release 17, CHO in MR-DC has been discussed but is generally limited to the scenario where the target MN can prepare a single target PSCell (e.g., under the control of an SN). Here, in a broad sense, it may be understood that with MR-DC, the master RAN (Radio Access Network) node functions as the controlling entity, utilizing a secondary RAN for additional data capacity. Example MR-DC configurations include (but is certainly not limited thereto) EN (E-UTRA-NR)-DC, NGEN (NG-RAN-E-UTRA)-DC, NE (NR-E-UTRA)-DC, or the like. However, the above-discussed scenario would generally limit the usefulness of the CHO MR-DC feature where UE may need to access different target PSCells when the CHO needs to be executed. Thus, there is a general need (e.g., in future 3GPP Releases) to specify mechanisms for CHO in MR-DC where target MN can prepare multiple target PSCells for the same target PCell.

In one WID (Work Item Description) of further NR (New Radio) mobility enhancements, one objective has been proposed to address the scenario of CHO+CPAC (Conditional PSCell Addition and Change) as follows:
To specify CHO including target MCG and candidate SCGs for CPC/CPA in NR-DC [RAN3, RAN2]:
   CHO including target MCG and target SCG is used as the baseline.

In short, the focus of the above objective may be seen to provide a configuration to a UE which may consist of both CHO and CPAC configurations, i.e., UE would conditionally handover to both PCell and PSCell, considering the execution conditions of each cell given in the handover configuration.

Further, in one of the meetings, the following has been agreed:
RAN2 agrees to support the simultaneous evaluation of CHO and CPC in Rel-18.
The UE should not need to unpack any of the nested conditional configuration containers in order to measure, according to the agreement above.

With this agreement, it was generally agreed that the UE should evaluate the CHO condition and CPC condition simultaneously.

Later, a further agreement has been achieved as well:
For the CHO+CPC (Conditional PSCell Change) case:
   When both CHO and CPC conditions are met, both CHO and CPC cell change is executed.
   Baseline: The UE waits until both CHO and CPC conditions are met (always). (Furthermore, it is assumed that if needed the network can provide a complementary CHO-only configuration, to avoid failures in deployments where failure would otherwise be likely to happen).
   Alternative: FFS (For Further Study) If when CHO condition is met, but CPC condition is not met, CHO execution is triggered (and somehow source SCG can be released). If allowed in the new configuration the UE may continue evaluation of CPC/CPA (Conditional PSCell Addition) conditions.

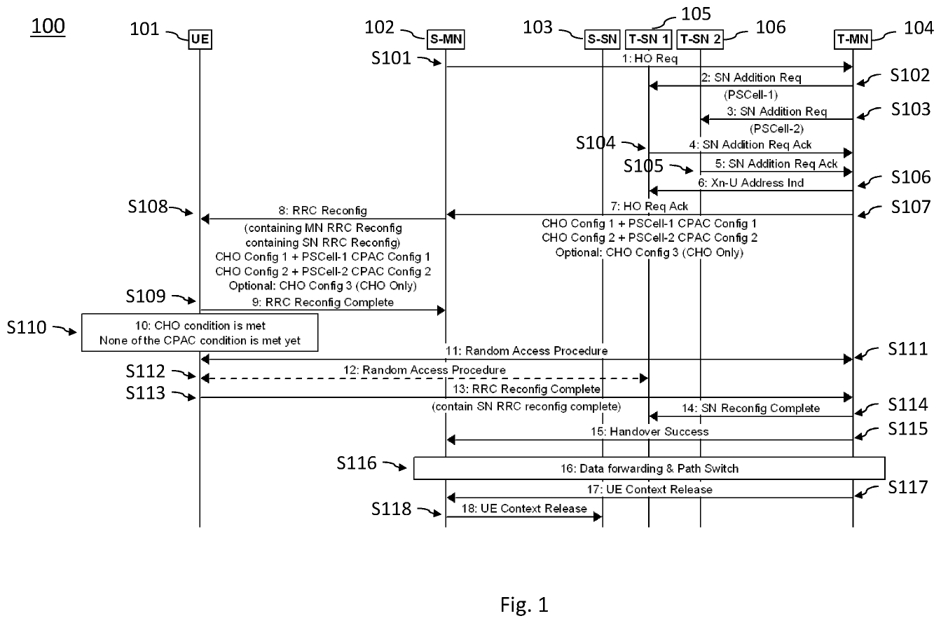

Now, for ease of understanding, an example scenario 100 for the CHO+CPAC mobility procedures and the corresponding signaling/messaging flow will be illustrated in a bit more detail with reference to FIG. 1. Generally speaking, in the illustrative example scenario 100 of FIG. 1, the UE 101 is served by the source MN (S-MN in short) 102 and it may optionally be also served by the source SN (S-SN in short) 103 if the UE is configured/deployed in a dual connectivity setup. The dual connectivity is an example of the multi connectivity. The multi-connectivity may refer to a scenario where more than two cells provide the UE with the independent communication paths. The following description focuses on the dual connectivity for the sake of clarity. When the S-MN 102 requests CHO preparation from the target MN (T-MN in short) 104, the T-MN 104 may be configured to provide the following configurations to the S-MN 102, namely:
CHO Config 1+PSCell-1 CPAC Config 1,
CHO Config 2+PSCell-2 CPAC Config 2, and
Optional: CHO Config 3 (i.e., CHO Only).

In particular, the first and the second configurations are dual connectivity configurations where the UE may access both PCell of the CHO configuration and PSCell of the CPAC configuration. In some possible implementations, the T-MN 104 may also provide an (optional) CHO only configuration as indicated above, which would then a single connectivity configuration (i.e., no PSCell, no SN).

It may be worthwhile to mention that, as can also be understood and appreciated by the skilled person, the scenario with two PSCells (PSCell-1 associated with target-SN (T-SN in short) 1 105 and PSCell-2 associated with target-SN (T-SN in short) 2 106) of FIG. 1 is merely shown as an illustrative (non-limiting) example. Depending on various implementations and/or circumstances, any other suitable deployment configuration/scenario may be considered.

To be more specific, in the example scenario 100 of FIG. 1, the S-MN 102 sends, in step S101 a HO Request message to the T-MN 104.

In steps S102 and S103, the T-MN 104 may prepare at least one PSCell and transmit a respective SN Addition Request message to at least one T-SN 105, 106 in. For instance, in the present example, the T-MN 104 prepares PSCell-1 and transmits this to T-SN 1 105 in an SN Addition Request for CPAC, and prepares PSCell-2 and transmits this to T-SN 2 106 in an SN Addition Request for CPAC. In some examples, CPAC may be configured along with the CHO configurations of the T-MN 104.

Accordingly, in steps S104 and S105, the T-SNs 105, 106 respond with a respective SN Addition Request Ack message to the T-MN 104.

In step S106, the T-MN 104 transmits an Xn-U Address Indication message to at least one T-SN 105, 106.

In step S107, the T-MN 104 transmits a HO Request Ack message to the S-MN 102. In some examples, the T-MN 104 may generate a set of 3 configurations as illustrated above and send them to the S-MN 102 in the HO Request Ack message. For instance, as exemplarily illustrated above, the configurations may comprise: a CHO configuration 1 of the target PCell and a CPAC configuration 1 of PSCell 1 (i.e., for a dual connectivity mobility/handover procedure); a CHO configuration 2 of the target PCell and a CPAC configuration 2 of PSCell 2 (i.e., for a dual connectivity mobility/handover procedure); and optionally, a further CHO configuration 3 of the target PCell (i.e., for a single connectivity mobility/handover procedure, without CPAC or PSCell). As can be understood and appreciated by the skilled person, the CHO configurations 1 to 3 may be the same or different, depending on various implementations and/or circumstances.

Subsequently, in step S108, the S-MN 102 generates and transmits an RRC Reconfiguration message to the UE 101. As may be understood and appreciated by the skilled person, such RRC Reconfiguration message may include, but is certainly not limited to, the respective CHO and CPAC configurations received from the T-MN in step S107, as well as any other suitable configurations, such as configuration ID (identifier), corresponding CHO and/or CPAC execution conditions (e.g., for each target cell, not shown in the figure), or the like. Notably, in some possible implementations, there may be one or more CHO configurations but one CHO (execution) condition associated with the target PCell. In some other possible implementations, it may also be possible that each CHO configuration would have (e.g., associated with) a respective (e.g., different) CHO (execution) condition. On the other hand, generally speaking, for each target PSCell, there would be a respective CPAC (execution) condition.

In step S109, the UE 101 sends an RRC Reconfiguration Complete message to the S-MN 102. In some examples, the RRC Reconfiguration Complete is to indicate that the RRC Reconfiguration in S108 has been successfully received (or successfully configured/executed).

As briefly mentioned earlier, now the UE 101 may initiate the dual connectivity handover only if both CHO and CPAC conditions are met. However, in case the CHO condition is met (e.g., at least one CHO condition is met) but the CPAC condition is not met (e.g., none of the CPAC conditions for PSCell-1 and PSCell 2 are met) as exemplarily indicated in step S110 of FIG. 1, the UE 101 would have the following two possible alternative behaviors to proceed.

In a first alternative, the UE 101 may be configured to wait until any CPAC condition holds. Put differently, in this case, the UE tries its best to perform dual connectivity handover with high throughput and low signaling overhead that would result in reestablishing the dual connectivity. However, after the CHO condition is met, it may take a longer time for the CPAC condition to be met. Since the CHO condition is already met, waiting longer may lead to interruption on the source PCell link (as the target PCell is already stronger) and the UE may experience a radio link failure.

In a second alternative, the UE 101 may be configured to (e.g., immediately) execute the CHO part of the CHO+CPAC configuration 1 or 2, or execute the CHO only configuration 3. This would generally prevent any interruption and robustness issues or problem on the PCell. However, in this case, the UE would be considered to have given up too quickly on the DC setup, which would eventually lead to high throughput loss (as most of the throughput is carried on the CPAC configuration) and/or increased signaling overhead when reestablishing the dual connectivity.

Notably, in either of the above alternatives, when the CHO condition is met but the CPAC condition is not met, there would be a trade-off between waiting for the CPAC condition to be met and executing the single connectivity handover.

Now returning to FIG. 1, in steps S111 and S112, once one of the CHO/CPAC conditions is met, the UE 101 performs a Random-Access Procedure. For instance, if the target PCell and one of the PSCell access/execution conditions are met, the UE 101 is handed over to the target PCell and the corresponding PSCell of which the access conditions have been met.

Accordingly, in step S113, the UE 101 may generate and send an RRC Reconfiguration Complete message for the executed configuration (e.g., any of the configurations 1 to 3). In some examples, the UE 101 may generate and send an RRC Reconfiguration Complete message for the T-MN's RRC Reconfiguration Complete message (for CHO) and a T-SN's RRC Reconfiguration Complete message (for CPAC). In some examples, the T-SN RRC Reconfiguration Complete message will be included in the RRC Reconfiguration Complete message. In some examples, the RRC Reconfiguration Complete may be for the executed CHO configuration and may be read by the T-MN 104. In some examples, the T-SN RRC Reconfiguration Complete is for the executed CPAC configuration that may be read by the respective T-SN (e.g., T-SN 1 105).

In step S114, the T-MN 104 transmits an SN Reconfiguration Complete message to the T-SN 105 associated with the selected (executed) configuration. For example, if the UE has executed CHO Config 1+CPAC PSCell-1 Config 1 where the PSCell-1 is associated with T-SN 1 105, the T-MN 104 sends the SN Reconfiguration Complete to T-SN 1 105.

In step S115, the T-MN 104 transmits a Handover Success message to the S-MN 102. For instance, the T-MN 104 may inform the S-MN 102 about the successful completion of the handover procedure from S-MN 102 to T-MN 104.

Finally, in subsequent steps S116 to S118, corresponding Data forwarding, Path Switch, and optionally UE Context Release (e.g., the UE 101 had been served by the S-SN 103 as well) steps are performed, for which the respective description will not be provided in detail for the sake of conciseness.

As has been noted above, in the above-illustrated implementation, there would always be a trade-off between waiting for the CPAC condition to be met and executing the single connectivity handover (which generally means throughput loss).

With the above in mind, in a broad sense, the present disclosure generally proposes to introduce a further suitable (e.g., preconfigured) condition (e.g., with suitable (preconfigured) threshold), hereinafter referred to as “strain condition”, particularly when the CHO condition is met but CPAC condition is not met in order to decide on the mobility (either waiting or executing the CHO), thereby possibly mitigating the above-illustrated trade-off. Generally speaking, such condition may either be provided by the network or may be a standard procedure that might be specified in the technical specification/standard, depending on various implementations.

As will be discussed in more detail below, in a broad sense, when the CHO condition is met but the CPAC condition is not met, the UE may be configured to check whether there is a radio link-related problem/issue, particularly with its connection towards the source PCell (and PSCell if configured), i.e., whether the UE suffers from an interruption in the source link (e.g., source PCell and optionally also source PSCell). If there appears to be no radio link problem with the source PCell or the radio link problem so detected appears to be below a threshold, thus, tolerable, the UE may be configured to wait for the CPAC condition to be met as there would generally be no harm of waiting for CPAC condition for the sake of handover with high throughput (provided that the CHO condition is still met). On the other hand, if the UE appears to experience any (intolerable) radio link problem state with the source PCell (and possibly with source PSCell), the UE might not delay the CHO access any further, i.e., the UE does not wait for the CPAC condition to be met and (immediately) execute either CHO only configuration or the CHO part of one of the CHO+CPAC configurations (depending on availability of the CHO only config).

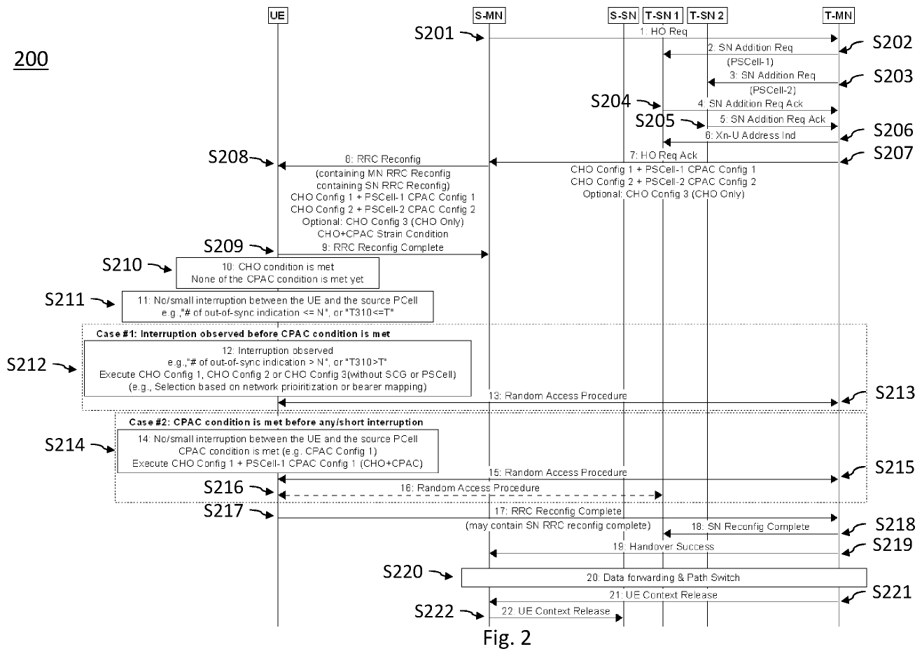

The above briefly illustrated concept of the present disclosure will now be described in more detail with reference to FIG. 2, which schematically illustrates an example of a CHO+CPAC scenario and corresponding signaling/messaging 200 according to some example embodiments of the present disclosure. As mentioned above, identical or like reference numbers and/or signaling/messaging used in FIGS. 1 and 2 may, unless indicated otherwise, indicate identical or like elements, such that repeated descriptions thereof may be omitted for reasons of conciseness.

Particularly, in the example of FIG. 2, in steps S201 to S208 (similar to those steps SS101 to S108 of FIG. 1), the S-MN may be configured to send a CHO request to the T-MN; the T-MN may be configured to provide two CHO+CPAC configurations 1 and 2, and optionally a CHO only configuration 3 (possibly together with respective corresponding execution conditions, which are not specifically shown in the figure). In other words, the UE may be configured with two CHO+CPAC configs and optionally with one CHO only configuration.

Notably, as illustratively shown in step S208 of the example 200 of FIG. 2, the S-MN may be configured to additionally (in comparison with step S108 of FIG. 1) include and provide a so-indicated CHO+CPAC strain condition to the UE, such that upon receipt of the UE may be enabled to check in case the CHO condition is met but CPAC condition is not met. It is to be noted that, although the term “strain condition” or the like may appear to have been used throughout the present disclosure, as will be understood and appreciated by the skilled person, such term might or could have a different or similar name, depending on various implementations and/or circumstances. Regardless of the naming being used, it is to be noted that the main purpose here may be understood to somehow indicate (enable) the UE to perform a further condition check, in order to possibly mitigate the above-illustrated trade-off and as a result, to maintain robustness for the main cell PCell (where condition applied first) and to maintain dual connectivity/throughput during cell switch as much as possible.

It may be worthwhile to mention that, as can also be understood and appreciated by the skilled person, in some possible implementations, this condition might not be (directly) provided by the S-MN, but instead, it might for example be a (e.g., predefined) procedure that could have been described in the standard. In that case, in some possible implementations, the network (e.g., the S-MN) may be configured to suitably indicate whether it would like the UE to follow that procedure or not, for example by sending a suitable indication to the UE, or the like. Accordingly, the “strain condition” may be preconfigured to the UE, either by storing it as a default condition/threshold(s) or by being suitably communicated to the UE beforehand, depending on various implementations and/or circumstances.

Subsequently, in step S209, the UE sends the RRC Reconfiguration Complete message after it receives the RRC Reconfiguration message in step S208, specifically to acknowledge the reception and application of the configuration.

Upon receipt of such CHO/CPAC configurations (possible together with corresponding execution conditions), the UE may be configured to (e.g., continuously) determine (evaluate) those execution conditions, and accordingly, as exemplarily indicated in step 210, the UE may determine that (any one of) the CHO condition is met but none of the CPAC conditions are met yet.

In such cases, particularly in compassion with the UE behaviors as illustrated with reference to FIG. 1, the UE may be configured to check the CHO+CPAC strain condition (e.g., received from the network or stored as a default parameter) to decide whether it should wait for (any of) the CPAC condition to be met.

Herein, two possible (non-limiting) example implementations for the “strain condition” are given for purposes of illustration and ease of understanding, where, generally speaking, both aim at somehow quantifying the radio link-related problems/issues (e.g., radio link failure, packet loss, out or loss of synchronization, decoding error, or the like), particularly between the source PCell (optionally also the source PSCell as mentioned above) and the UE.

In a first possible example, an out-of-sync indication may be used. Particularly, in the case that the lower layer(s), such as the physical and/or MAC layer (of the UE), identify any out-of-sync due to for example degraded radio conditions, the lower layer(s) may be configured to send one or more out-of-sync indications to the higher layers, such as the RRC layer. The out-of-sync indication may be based on radio measurements or tracking synchronization performance, for example. Accordingly in such an example, the UE may be configured to check or measure the number/count of out-of-sync indications received in the higher layers and possibly further to compare the measure number/count with at least one (e.g., preconfigured) threshold. For instance, in some possible implementations, if the number of out-of-sync indications so detected does not exceed the certain predetermined or preconfigured value, such as N, the UE may be configured to wait for the CPAC condition to be met as long as the CHO condition is still met. If the number of out-of-sync indications so detected exceeds the certain predetermined or preconfigured value, such as N, the UE may be configured to execute the CHO. Depending on various implementations and/or requirements, the number N representing a threshold for triggering the execution of the CHO without the CPAC may be set to zero or any suitable value larger than zero. Notably, when it is set to zero, it generally means that there is no tolerance for interruption when the CHO condition is met.

In a second possible example, a time (either newly defined or existing/preconfigured) timer may be used. For instance, in some possible implementations, an existing T310 timer (which has generally been used to indicate physical layer problems detected) may be considered. In such a case, the UE may be configured to start the T310 timer (or an equivalent or similar timer) upon detecting persistent physical layer problems, i.e., the out-of-sync in the lower layers. Particularly, in this case, if the T310 timer has been running for a time interval shorter than a certain (e.g., predetermined) period of time, such as T, the UE may be configured to wait for the CPAC condition to be met as long as the CHO condition is still met. If the T310 timer has been running for a time interval that reaches T or exceeds T, the UE may be configured to trigger the execution of the CHO without the CPAC. Similar to the above N, the number T can also be set to zero or any value larger than zero. Also, when it is set to zero, it generally means that there is no tolerance for persistent interruption or risk of failure when the CHO condition is met.

As noted earlier, the above two example implementations for the “strain condition”, namely the out-of-sync indication and the timer status, are merely provided for illustrative purposes, but should not be considered as a limitation of any kind. Of course, such strain condition may be implemented in any other suitable manner, depending on various circumstances and/or requirements, as can also be understood and appreciated by the skilled person. Also, both thresholds T and N may be used concurrently. For example, the execution of the CHO may be triggered when both thresholds have been exceeded. While either threshold has not yet been exceeded, the UE may refrain from executing the CHO until the CPAC condition is met.

Returning to the example of FIG. 2, as schematically shown in step S211, since the interruption condition is not met yet (e.g., the number of out-of-sync indications is less than or equal to the predefined indication threshold N, and/or the running time period or interval (status) of the timer T310 (or any other suitable timer) is less than or equal to the predefined timing threshold T), or in other words, the UE is not yet experiencing any (or low) radio link problem state, the UE may be configured to wait for the CPAC condition to be met.

Accordingly, there would generally be two possible cases, which are schematically shown in steps S212 and S214 of FIG. 2, respectively.

To be more specific, the first case may generally refer to the case that the interruption condition is met before (any one of) the CPAC condition is met.

In this case, as illustratively shown in step S212, the UE may be considered to experience any (or short/minor, depending on the setting of the respective threshold) interruption that may lead the interruption related conditions to be met, the UE may stop waiting for the CPAC condition to be met. At that time, if the CHO condition is still met, the UE may be configured to execute the CHO configuration part of any one of the CHO+CPAC configurations, or the CHO only configuration (if any). In some possible implementations, if there should be more than one CHO configuration, the UE may be configured to select one configuration based on any suitable criteria, which may include, but is certainly not limited to:
prioritization indicated per configuration (e.g., (pre-)determined by the network),
CPAC condition status, e.g., TTT (Time-To-Trigger) status of the CPAC conditions of each CPAC configuration,
signal strengths of the PSCells of each CPAC configuration,
a predetermined bearer mapping,
or the like.

Accordingly, the UE would select one of the CHO configurations based on the selection criteria and access to T-MN using that configuration (step S213).

In contrast, the second case may generally refer to the case that (any one of) the CPAC condition is met before any/short interruption.

Particularly, in this case, as illustratively shown in step S214, the UE may be considered to have not experienced (or detected) any (or short/minor, depending on the setting of the respective threshold) interruption that may lead the interruption condition to be met, the UE may be configured to wait for the CPAC condition as explained above. In other words, the CPAC condition is met before the UE experiences any/short interruption and the UE may be configured to execute the CHO+CPAC configuration which is associated with the CPAC condition that has been met.

For instance, in the present example, the CPAC condition of the CPAC config 1 is met, so that the UE executes the corresponding CHO Config 1 and CPAC config 1. Accordingly, the UE will be able to access both T-MN and T-SN1 (steps S215 and S216), thus maintaining dual connectivity.

In the remaining steps S217 to S222 (which respectively correspond to steps S113 to S118 of FIG. 1), the UE and the network may proceed with the completion of the handover procedure, and the respective description thereof is thus omitted for the sake of conciseness.

To summarize the above, according to the techniques proposed throughout the present disclosure, when cell switch conditions apply only partially (e.g., CHO condition is met but CPAC condition is not met), the cell switch may be delayed allowing other condition(s) to comply as well, unless a user data interruption (e.g., radio link related problem state) is detected (for the cell where the condition already applies) and it continues more than what is determined to be sustainable, as defined by the threshold(s) such as T or N. Particularly, by the introduction of an additional check condition (i.e., the so-referenced “strain condition”) that is applied specifically when the CHO condition is met but the CPAC condition is not met, the UE may be enabled to perform a further check on possible radio link related problem/issue state, in order to possibly mitigate the above-illustrated trade-off between waiting for the CPAC condition to be met and executing the single connectivity handover; and as a result, to maintain robustness for the main cell (i.e., PCell, where the condition applied first) and to maintain dual connectivity/high throughput during cell switch as much as possible, thereby helping to improve the overall system efficiency and possibly also to reduce signaling overhead that would result in attempting to reestablish the dual connectivity.

For the sake of completeness, it is noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

It is also to be noted that, although some of the example embodiments above may appear to be described with respect to the dual connectivity/DC setup, analogous or similar descriptions may also be considered applicable or expandable to multi-connectivity (MC) setup as well (possibly with suitable adaptation or modification, if necessary), as may be understood and appreciated by the skilled person.

It should also be noted that the apparatus (or system) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the source/target gNB, MN, SN, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

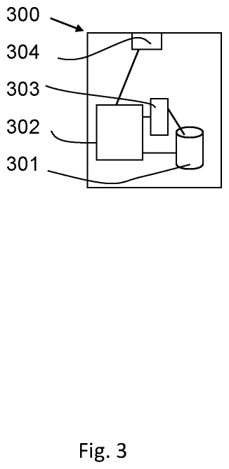

An illustrative (non-limiting) example for such an apparatus 300 is schematically shown in FIG. 3. The apparatus 300 may be configured to implement a UE, or a serving/source network node (e.g., the S-MN 102 in FIG. 1) as proposed in the present disclosure. In some possible cases, the apparatus 300 may also be implemented as any suitable network node/component/element/entity for a communications system, for example, to be coupled to and/or for controlling a station of an access system, such as a RAN node, e.g. a base station, eNB or gNB, a relay node or a core network node such as an MME or S-GW or P-GW, or a core network function such as AMF, SMF, LMF, a server or host, or in some possible implementations, a UE. Depending on various implementations, the method as described in the present disclosure may be implemented in a single apparatus or across more than one apparatus. The apparatus may be integrated with or external to a node or module of a core network, RAN, or the like. In particular, apparatus 300 may be arranged to provide control of communications in the service area of the system. The apparatus 300 may comprise at least one memory 301, at least one data processing unit (or circuitry) 302, 303, and an input/output interface 304. Via interface 304 the apparatus 300 may be coupled to any other suitable component (e.g., a receiver and/or a transmitter) of the apparatus 300, or to any other suitable other apparatus(es). In some possible examples, the receiver and/or the transmitter may be implemented as a radio front end or a remote radio head, depending on various implementations and/or circumstances.

Yet in some other example embodiments, there is provided a respective apparatus (e.g., implementing the UE, the source network node, etc., as described above) that comprises respective means configured to at least perform the respective steps as described above.

According to some further example embodiments, there are also provided corresponding methods suitable to be carried out by suitable apparatuses (network elements/nodes/components) as described above, such as the UE, the source network element, or the like.

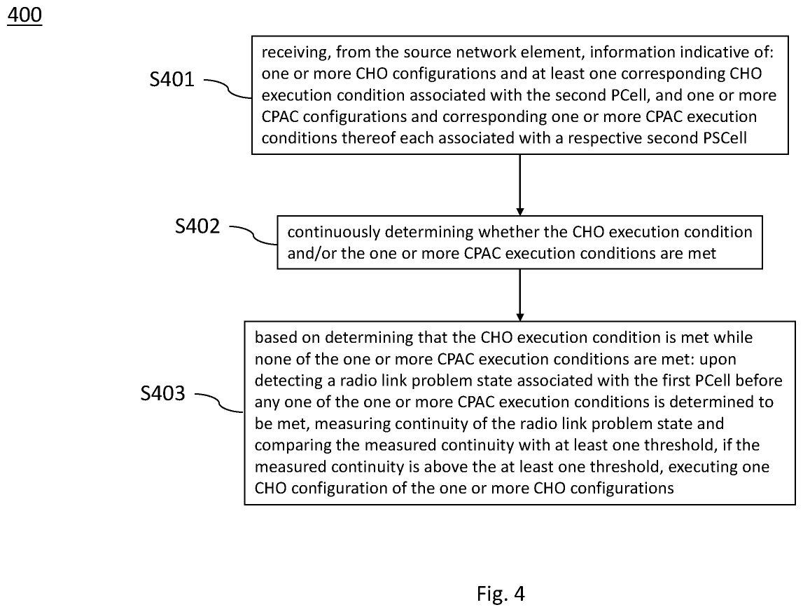

In particular, FIG. 4 schematically shows a flowchart illustrating an example of a method 400 that may be performed for example by a UE according to some example embodiments of the present disclosure.

Specifically, method 400 may comprise, at step S401, receiving, from a source network element, information indicative of: one or more CHO configurations and at least one corresponding CHO execution condition associated with the second PCell, and one or more CPAC configurations and corresponding one or more CPAC execution conditions thereof each associated with a respective second PSCell. Method 400 may further comprise, at step S402, continuously determining whether the CHO execution condition and/or the one or more CPAC execution conditions are met. Finally, method 400 may yet comprise, at step S403, based on determining that the CHO execution condition is met while none of the one or more CPAC execution conditions are met: upon detecting a radio link problem state associated with the first PCell before any one of the one or more CPAC execution conditions is determined to be met, measuring continuity of the radio link problem state and comparing the measured continuity with at least one threshold, if the measured continuity is above the at least one threshold, executing one CHO configuration of the one or more CHO configurations.

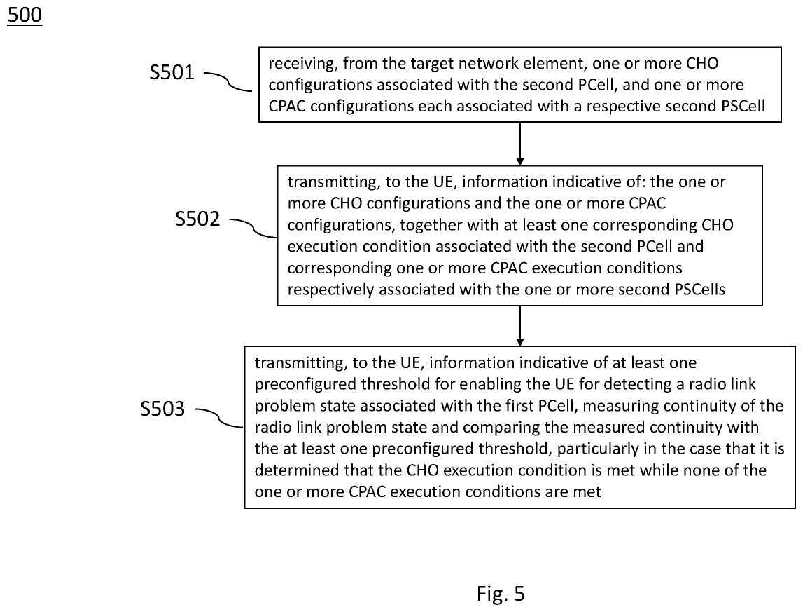

Similarly, FIG. 5 schematically shows another flowchart illustrating an example of a method 500 that may be performed for example by a source network element according to some example embodiments of the present disclosure.

Specifically, method 500 may comprise, at step S401, receiving, from a target network element, one or more CHO configurations associated with the second PCell, and one or more CPAC configurations each associated with a respective second PSCell. Method 500 may further comprise, at step S502, transmitting, to a UE, information indicative of: the one or more CHO configurations and the one or more CPAC configurations, together with at least one corresponding CHO execution condition associated with the second PCell and corresponding one or more CPAC execution conditions respectively associated with the one or more second PSCells. Finally, method 500 may yet comprise, at step S503, transmitting, to the UE, information indicative of at least one preconfigured threshold for enabling the UE for detecting a radio link problem state associated with the first PCell, measuring continuity of the radio link problem state and comparing the measured continuity with the at least one preconfigured threshold, particularly in the case that it is determined that the CHO execution condition is met while none of the one or more CPAC execution conditions are met.

It is to be noted that examples of embodiments of the disclosure are applicable to various different network configurations. In other words, the examples shown in the above-described figures, which are used as a basis for the above-discussed examples, are only illustrative and do not limit the present disclosure in any way. That is, additional further existing and proposed new functionalities available in a corresponding operating environment may be used in connection with examples of embodiments of the disclosure based on the principles defined.

It should also be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiments outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1. A user equipment, UE, configured for supporting a conditional handover, CHO, procedure in a multi connectivity, MC, setup involving a source network element and at least one target network element, the source network element being associated with a first primary cell, PCell, and optionally a first primary secondary cell, PSCell, serving the UE; the target network element being associated with a second PCell and one or more second PSCells for supporting a conditional PSCell addition and change, CPAC, procedure; and the UE comprising:
at least one processor; and
at least one memory storing instructions that, when executed by the at least one processor, cause the UE at least to:
receive, from the source network element, information indicative of: one or more CHO configurations and at least one corresponding CHO execution condition associated with the second PCell, and one or more CPAC configurations and corresponding one or more CPAC execution conditions thereof each associated with a respective second PSCell;
continuously determine whether the CHO execution condition and/or the one or more CPAC execution conditions are met; and
based on determining that the CHO execution condition is met while none of the one or more CPAC execution conditions are met:
upon detecting a radio link problem state associated with the first PCell before any one of the one or more CPAC execution conditions is determined to be met, measuring continuity of the radio link problem state and comparing the measured continuity with at least one threshold, if the measured continuity is above the at least one threshold, execute one CHO configuration of the one or more CHO configurations.

2. The UE according to claim 1, wherein the UE is further caused to:
based on determining that a CPAC execution condition of the one or more CPAC execution conditions is met before the radio link problem state associated with the first PCell is detected or before the measured continuity of radio link problem state associated with the first PCell becomes above the at least one threshold:
execute the CPAC configuration corresponding to the CPAC execution condition and the CHO configuration associated with the CPAC configuration.

3. The UE according to claim 1, wherein the at least one threshold is preconfigured to the UE.

4. The UE according claim 1, wherein the measured continuity and comparison with the at least one threshold involve at least one of: a count of out-of-sync indications detected by the UE relative to a predetermined indication threshold N, or a running period of a preconfigured timer relative to a predetermined timing threshold T, where each of N and T is a value larger than or equal to 0.

5. The UE according to claim 4, wherein the measured continuity and comparison with the at least one threshold involve:
if the count of out-of-sync indications detected by the UE is larger than the predetermined indication threshold N, and/or if the running period of the preconfigured timer is larger than the predetermined timing threshold T, executing the one CHO configuration of the one or more CHO configurations.

6. The UE according to claim 3, wherein the UE is further caused to:
receive the at least one threshold from the source network element.

7. The UE according to claim 3, wherein the UE is configured to receive the preconfigured at least one threshold from the source network element in a radio resource control, RRC, reconfiguration message.

8. The UE according to claim 1, wherein, if there are at least two CHO configurations, the executing one CHO configuration involves:
selecting, based on a predetermined criterion, one CHO configuration from the at least two CHO configurations for execution; and
executing the selected CHO configuration.

9. The UE according to claim 8, wherein the predetermined criterion involves at least one of: a predetermined configuration prioritization, a corresponding CPAC condition status, such as time to trigger, TTT, status of each CPAC configuration, a corresponding signal strength of the respective second PSCell associated with each CPAC configuration, or a predetermined bearer mapping.

10. The UE according to claim 1, wherein the one or more CHO configurations relate to a radio access technology, RAT, different from that of the one or more CPAC configurations.

11. A source network element configured for supporting a conditional handover, CHO, procedure in a multi connectivity, MC, setup involving at least one target network element and a user equipment, UE, served by a first primary cell, PCell, and optionally a first primary secondary cell, PSCell, of the source network element; the target network element being associated with a second PCell and one or more second PSCells for supporting a conditional PSCell addition and change, CPAC, procedure; and the source network element comprising:
at least one processor; and
at least one memory storing instructions that, when executed by the at least one processor, cause the source network element at least to:
receive, from the target network element, one or more CHO configurations associated with the second PCell, and one or more CPAC configurations each associated with a respective second PSCell;
transmit, to the UE, information indicative of: the one or more CHO configurations and the one or more CPAC configurations, together with at least one corresponding CHO execution condition associated with the second PCell and corresponding one or more CPAC execution conditions respectively associated with the one or more second PSCells; and
transmit, to the UE, information indicative of at least one preconfigured threshold for enabling the UE for detecting a radio link problem state associated with the first PCell, measuring continuity of the radio link problem state and comparing the measured continuity with the at least one preconfigured threshold, particularly in the case that it is determined that the CHO execution condition is met while none of the one or more CPAC execution conditions are met.

12. A method of a user equipment, UE, for supporting a conditional handover, CHO, procedure in a multi connectivity, MC, setup involving a source network element and at least one target network element, the source network element being associated with a first primary cell, PCell, and optionally a first primary secondary cell, PSCell, serving the UE; the target network element being associated with a second PCell and one or more second PSCells for supporting a conditional PSCell addition and change, CPAC, procedure; and the method comprising:
receiving, from the source network element, information indicative of: one or more CHO configurations and at least one corresponding CHO execution condition associated with the second PCell, and one or more CPAC configurations and corresponding one or more CPAC execution conditions thereof each associated with a respective second PSCell;
continuously determining whether the CHO execution condition and/or the one or more CPAC execution conditions are met; and
based on determining that the CHO execution condition is met while none of the one or more CPAC execution conditions are met:
upon detecting a radio link problem state associated with the first PCell before any one of the one or more CPAC execution conditions is determined to be met, measuring continuity of the radio link problem state and comparing the measured continuity with at least one threshold, if the measured continuity is above the at least one threshold, executing one CHO configuration of the one or more CHO configurations.

13. The method according to claim 12, wherein the UE further performs the following:
based on determining that a CPAC execution condition of the one or more CPAC execution conditions is met before the radio link problem state associated with the first PCell is detected or before the measured continuity of radio link problem state associated with the first PCell becomes above the at least one threshold:
execute the CPAC configuration corresponding to the CPAC execution condition and the CHO configuration associated with the CPAC configuration.

14. The method according to claim 12, wherein the at least one threshold is preconfigured to the UE.

15. The method according to claim 12, wherein the measured continuity and comparison with the at least one threshold involve at least one of: a count of out-of-sync indications detected by the UE relative to a predetermined indication threshold N, or a running period of a preconfigured timer relative to a predetermined timing threshold T, where each of N and T is a value larger than or equal to 0.

16. The method according to claim 15, wherein the measured continuity and comparison with the at least one threshold involve:
if the count of out-of-sync indications detected by the UE is larger than the predetermined indication threshold N, and/or if the running period of the preconfigured timer is larger than the predetermined timing threshold T, executing the one CHO configuration of the one or more CHO configurations.

17. The method according to claim 14, wherein the UE receives the at least one threshold from the source network element.

18. The method according to claim 14, wherein the UE receives the preconfigured at least one threshold from the source network element in a radio resource control, RRC, reconfiguration message.

19. The method according to claim 12 wherein, if there are at least two CHO configurations, the executing one CHO configuration involves:
selecting, based on a predetermined criterion, one CHO configuration from the at least two CHO configurations for execution; and
executing the selected CHO configuration.

20. (canceled)

21. The method according to claim 12, wherein the one or more CHO configurations relate to a radio access technology, RAT, different from that of the one or more CPAC configurations.

22-25. (canceled)
